(19) United States
(12) Patent Application Publication
(10) Pub. No.: US 2015/0360943 A1
(43) Pub. Date: Dec. 17, 2015

(54) PROCESS FOR PRODUCING HYDROGEN CYANIDE AND RECOVERING HYDROGEN

(71) Applicant: INVISTA TECHNOLOGIES S.A.R.L., St. Gallen (CH)

(72) Inventors: John C. CATON, Yoakum, TX (US); David W. RABENALDT, Port Lavaca, TX (US)

(73) Assignee: INVISTA NORTH AMERICA S.A R.L., Wilmington, DE (US)

(21) Appl. No.: 14/741,778

(22) PCT Filed: Dec. 12, 2013
(86) PCT No.: PCT/US2013/074682

§ 371 Date: Jun. 17, 2015

Related U.S. Application Data
(60) Provisional application No. 61/738,747, filed on Dec. 18, 2012.

(51) Int. Cl. C01B 3/38; C01C 3/02

(52) U.S. Cl. CPC C01B 3/38; C01C 3/0212; C01B 2203/0233; C01B 2203/042

(57) ABSTRACT

Described is a process for the production and recovery of hydrogen cyanide, which includes recovering hydrogen from a crude hydrogen cyanide product. The process includes forming a crude hydrogen cyanide product and separating the crude hydrogen cyanide product to form an off-gas stream and a hydrogen cyanide product stream. The off-gas stream is further separated to recover hydrogen. The hydrogen cyanide product stream is further processed to recover hydrogen cyanide.

### CROSS REFERENCE TO RELATED APPLICATION

This application claims priority to U.S. App. No. 61/738,747, filed Dec. 18, 2012, the entire contents and disclosures of which are incorporated herein.

### FIELD OF THE INVENTION

The present invention is directed to a process for manufacturing hydrogen cyanide and recovering hydrogen. In particular, the present invention is directed to improving process efficiency by recovering a hydrogen product stream and a hydrogen cyanide product stream from a crude hydrogen cyanide product.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. No. 1,934,838 and U.S. Pat. No. 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane (See e.g., Ullman's Encyclopedia of Industrial Chemistry, Volume A8, Weinheim 1987, pages 161463). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

U.S. Pat. No. 2,797,148 discloses the recovery of ammonia from a gaseous mixture containing ammonia and hydrogen cyanide. A reaction off-gas, from the process of preparing hydrogen cyanide by reacting ammonia with a hydrocarbon-bearing gas and an oxygen-containing gas, comprises ammonia, hydrogen cyanide, hydrogen, nitrogen, water vapor and carbon oxides. The off-gas is cooled to a temperature of 55 to 90° C. and is then led into an absorption tower for separation of ammonia from the off-gas.

U.S. Pat. No. 3,647,388 discloses a process for the manufacture of hydrogen cyanide from a gaseous hydrocarbon of up to six carbon atoms, such as methane, and ammonia. The preferred process is carried out in a burner having a center conduit for the flow of an oxygen bearing stream and one or more annular conduits adjacent to the center conduit for the concurrent flow of hydrogen, ammonia and the gaseous hydrocarbon, the conduits ending in a reaction chamber where the gaseous hydrocarbon and ammonia react at the flame front of the hydrogen and oxygen combustion flame. The process eliminates the use of a catalyst.

Although the Andrussow process and recovery of HCN are known, there has been little if any disclosure related to separating the off-gas to recover a hydrogen product stream from a catalytic HCN production process.

Thus, the need exists for processes that produce HCN in the presence of a catalyst and that can also recover hydrogen from a reactor off-gas.

The published documents mentioned above are hereby incorporated by reference.

### SUMMARY OF THE INVENTION

In one embodiment, the present invention is directed to a process for producing hydrogen cyanide comprising: (a) determining methane content of a methane-containing gas and purifying the methane-containing gas when the methane content is determined to be less than 90 vol. %; (b) reacting a ternary gas mixture comprising at least 25 vol. % oxygen in the presence of a catalyst to form a crude hydrogen cyanide product comprising hydrogen cyanide and off-gas, the ternary gas mixture comprising a methane-containing gas formed by purifying a methane-containing source comprising less than 90 vol. % methane, an ammonia-containing gas, and an oxygen-containing gas; (c) separating the crude hydrogen cyanide product to form a hydrogen cyanide product stream comprising hydrogen cyanide and an off-gas stream comprising hydrogen, water, carbon monoxide, and carbon dioxide; (d) separating the off-gas stream to form a hydrogen product stream comprising hydrogen, and a purge stream comprising carbon monoxide, carbon dioxide and water; and (e) recovering hydrogen cyanide from the hydrogen cyanide product stream. In some embodiments, the ternary gas mixture may comprise at least 28 vol. % oxygen. The oxygen-containing gas may comprise greater than 21 vol. % oxygen, e.g., at least 80 vol. % oxygen, at least 90 vol. %, at least 95 vol. % or at least 99 vol. %. The off-gas stream may comprise from 40 to 90 vol. % hydrogen, from 0.1 to 20 vol. % water, from 0.1 to 20 vol. % carbon monoxide and from 0.1 to 20 vol. % carbon dioxide.

In the embodiments disclosed herein, the off-gas stream may be separated using a pressure swing adsorber and each adsorption bed in the pressure swing adsorber may adsorb non-hydrogen components in the off-gas. The pressure swing adsorber may be operated at a pressure from 1400 kPa to 2400 kPa and at a temperature from 16 to 55° C. The pressure swing adsorber may comprise at least two adsorption beds. Each adsorption bed may comprise at least one adsorbent, including zeolites, activated carbon, silica gel, alumina, and combinations thereof. In some embodiments, each adsorption bed comprises at least three adsorbents. The adsorbents in each bed may be the same or different. In the embodiments disclosed herein, the hydrogen product stream may comprise at least 95 vol. % hydrogen, e.g., at least 99 vol. %, at least 99.5 vol. % or at least 99.9 vol. %. The hydrogen cyanide product stream comprises less than 10 vol. % hydrogen, e.g., less than 5 vol. %, less than 1 vol. %, or is substantially free of hydrogen. At least 70 vol. % of hydrogen in the crude hydrogen cyanide product may be recovered in the hydrogen product stream, e.g., at least 75 vol. %. The crude hydrogen cyanide product and the hydrogen cyanide product stream may each further comprise ammonia. Step (c) of the process may further comprise separating the crude hydrogen cyanide product to form an ammonia stream. The ammonia stream may be returned to the reactor.

In another embodiment, the present invention is directed to a process for producing hydrogen cyanide comprising: (a) determining methane content of a methane-containing gas and purifying the methane-containing gas when the methane content is determined to be less than 90 vol. %; (b) reacting a ternary gas mixture comprising at least 25 vol. % oxygen in the presence of a catalyst to form a crude hydrogen cyanide product comprising hydrogen cyanide and off-gas, the ternary gas mixture comprising a methane-containing gas formed by purifying a methane-containing source comprising less than 90 vol. % methane, an ammonia-containing gas, and an oxygen-containing gas; (c) separating the crude hydrogen cyanide product to form a hydrogen cyanide product stream comprising hydrogen cyanide, an ammonia stream, and an off-gas stream comprising hydrogen, water, carbon monoxide, and carbon dioxide; (d) separating the off-gas stream to form a hydrogen product stream comprising hydrogen, and a purge stream comprising carbon monoxide, carbon dioxide and water; and (e) recovering hydrogen cyanide from the hydrogen cyanide product stream. At least a portion of the ammonia stream may be returned to the reactor.

In yet another embodiment, the present invention is directed to a process for recovering hydrogen from an Andrussow process comprising: (a) determining methane content of a methane-containing gas and purifying the methane-containing gas when the methane content is determined to be less than 90 vol. %; (b) reacting a ternary gas mixture comprising at least 25 vol. % oxygen in the presence of a catalyst to form a crude hydrogen cyanide product comprising hydrogen cyanide and off-gas, the ternary gas mixture comprising a methane-containing gas formed by purifying methane-containing source comprising less than 90 vol. % methane, an ammonia-containing gas, and an oxygen-containing gas; (c) separating the crude hydrogen cyanide product to form a hydrogen cyanide product stream comprising hydrogen cyanide and an off-gas stream comprising hydrogen, water, carbon monoxide, and carbon dioxide; (d) separating the off-gas stream in a pressure swing adsorber to recover hydrogen. The pressure swing adsorber may be operated at a pressure from 1400 kPa to 2400 kPa and at a temperature from 16 to 55° C. The pressure swing adsorber may comprise at least two adsorption beds. Each adsorption bed may comprise at least one adsorbent. The adsorbents in each bed may be the same or different. The hydrogen product stream may comprise at least 95 vol. % hydrogen, e.g., at least 99 vol. %, at least 99.5 vol. % or at least 99.9 vol. %. The hydrogen cyanide product stream comprises less than 10 vol. % hydrogen, e.g., less than 5 vol. %, less than 1 vol. %, or is substantially free of hydrogen. At least 70 vol. % of hydrogen in the crude hydrogen cyanide product may be recovered in the hydrogen product stream, e.g., at least 72.5 vol. %.

### BRIEF DESCRIPTION OF THE DRAWINGS

FIG. 1 is a schematic representation of one HCN production and recovery system.

### DETAILED DESCRIPTION OF THE INVENTION

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

The present invention provides a method of increasing process efficiency in the recovery of HCN and hydrogen from a crude hydrogen cyanide product. The present invention further provides a system (also referred to herein as “apparatus”) that can perform the method.

In the Andrussow process for forming HCN, methane, ammonia and oxygen raw materials are reacted at temperatures above about 1000° C. in the presence of a catalyst to produce a crude hydrogen cyanide product comprising HCN, hydrogen, carbon monoxide, carbon dioxide, nitrogen, residual ammonia, residual methane, and water. These components, i.e., the raw materials are provided to the reactor as a ternary gas mixture comprising an oxygen-containing gas, an ammonia-containing gas and a methane-containing gas. As would be understood by one of ordinary skill in the art, the source of the methane may vary and may be obtained from renewable sources such as landfills, farms, biogas from fermentation, or from fossil fuels such as natural gas, oil accompanying gases, coal gas, and gas hydrates as further described in VN Parmon, “Source of Methane for Sustainable Development”, pages 273-284, and in Derouane, eds. Sustainable Strategies for the Upgrading of Natural Gas: Fundamentals, Challenges, and Opportunities (2003). For purposes of the present invention, the methane purity and the consistent composition of the methane-containing source is of significance. In some embodiments, the process may comprise determining methane content of the methane-containing source and purifying the methane-containing source when the methane content is determined to be less than 90 vol. %. Methane content may be determined using gas chromatograph-based measurements, including Raman Spectroscopy. The methane content may be determined continuously in real time or as needed when new sources of methane-containing sources are introduced into the process. In addition, to achieve higher purities, the methane-containing source may be purified when the methane content is above 90 vol. %, e.g., from 90 to 95 vol. %. Known purification methods may be used to purify the methane-containing source to remove oil, condensate, water, C2+ hydrocarbons (e.g., ethane, propane, butane, pentane, hexane, and isomers thereof), sulfur, and carbon dioxide.

Natural gas is typically used as the source of methane while air, oxygen-enriched air, or pure oxygen can be used as the source of oxygen. The ternary gas mixture is passed over a catalyst to form a crude hydrogen cyanide product. The crude hydrogen cyanide product is then separated to recover HCN. In the present invention, the crude hydrogen cyanide product is also separated to recover hydrogen.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. In some embodiments, oxygen-enriched air comprises at least 28 vol. % oxygen, e.g., at least 80 vol. % oxygen, at least 95 vol. % oxygen, or at least 99 vol. % oxygen.

The term “natural gas” as used herein refers to a mixture comprising methane and optionally ethane, propane, butane, carbon dioxide, oxygen, nitrogen, and hydrogen sulfide. Natural gas may also comprise trace amounts of rare gases including helium, neon, argon and xenon. In some embodiments, natural gas may comprise less than 90 vol. % methane.

The formation of HCN in the Andrussow process is often represented by the following generalized reaction:

2CH₄+2NH₃+3O₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

Three basic side reactions also occur during the synthesis of HCN:

CH₄+H₂O→CO+3H₂

2CH₄+3O₂→2CO+4H₂O

4NH₃+3O₂→2N₂+6H₂O

In addition to the amount of nitrogen generated in the side reactions, additional nitrogen may be present in the crude product, depending on the source of oxygen. Although the prior art has suggested that oxygen-enriched air or pure oxygen can be used as the source of oxygen, the advantages of using oxygen-enriched air or pure oxygen have not been fully explored. See, e.g., U.S. Pat. No. 6,596,251. When using air as the source of oxygen, the crude hydrogen cyanide product comprises the components of air, e.g., approximately 78 vol. % nitrogen, and the nitrogen produced in the ammonia and oxygen side reaction.

Due to the large amount of nitrogen, it is advantageous to use oxygen-enriched air in the synthesis of HCN because the use of air as the source of oxygen in the production of HCN results in the synthesis being performed in the presence of a larger volume of inert gas (nitrogen) necessitating the use of larger equipment in the synthesis step and resulting in a lower concentration of HCN in the product gas. Additionally, because of the presence of the inert nitrogen, more methane is required to be combusted in order to raise the temperature of the ternary gas mixture components to a temperature at which HCN synthesis can be sustained. The crude hydrogen cyanide product contains the HCN and also by-product hydrogen, methane combustion byproducts (carbon monoxide, carbon dioxide, water), residual methane, and residual ammonia. However, when using air (i.e., approximately 21 vol. % oxygen), after separation of the HCN and recoverable ammonia from the other gaseous components, the presence of the inert nitrogen renders the residual gaseous stream with a fuel value that may be lower than desirable for energy recovery.

Therefore, the use of oxygen-enriched air or pure oxygen instead of air in the production of HCN provides several benefits, including the ability to recover hydrogen. Additional benefits include an increase in the conversion of natural gas to HCN and a concomitant reduction in the size of process equipment. Thus, the use of oxygen-enriched air or pure oxygen reduces the size of the reactor and at least one component of the downstream gas handling equipment through the reduction of inert compounds entering the synthesis process. The use of oxygen-enriched air or pure oxygen also reduces the energy consumption required to heat the oxygen-containing feed gas to reaction temperature.

When an air comprising 21 vol. % or less oxygen is used, the amount of nitrogen makes recovery of hydrogen impractical due to energy and economic considerations. Surprisingly and unexpectedly, it has been discovered that when using oxygen-enriched air or pure oxygen, hydrogen may be recovered from a crude hydrogen cyanide product in an efficient and economic method, e.g., using a pressure swing adsorber. The hydrogen that is recovered has a high level of purity and thus may be used in further processes without the need for additional processing.

When the crude hydrogen cyanide product is formed using oxygen-enriched air or pure oxygen, it is desirable to process the off-gas from the crude hydrogen cyanide product to recover the hydrogen content rather than burn the off-gas in a boiler. The off-gas may be separated from the crude hydrogen cyanide product using an absorber. The hydrogen can be recovered from at least a portion of the off-gas using pressure swing adsorption (PSA), membrane separation, or other known purification/recovery methods. In some embodiments, a PSA unit is used to recover hydrogen. In such instance, the gas is first compressed from 130 kPa to 2600 kPa, e.g., from 130 kPa to 2275 kPa, from 130 kPa to 1700 kPa, or from 136 kPa to 1687 kPa, and is then sent to the PSA unit. Unless otherwise indicated as gauge, all pressures are absolute. The high purity recovered hydrogen is more valuable as a raw material than as a fuel and as such may be used as a feed stream to another process such as in the hydrogenation of hydrogenation of benzene to cyclohexane. See Wittcoff et al., Industrial Organic Chemicals in Perspective Part I: Raw Materials and Manufacture (1991), pp. 92-93, the entirety of which is hereby incorporated by reference. The high purity recovered hydrogen may also be used in the hydrogenation of adiponitrile (ADN) to 6-aminocapronitrile (ACN) and hexamethylenediamine (HMD). The high purity recovered hydrogen may additionally be used in the catalytic hydrogenation of cyclohydroperoxide to cyclohexanol and cyclohexanone. See U.S. Pat. No. 6,703,529, the entirety of which is hereby incorporated by reference. The high purity recovered hydrogen may also be used in the production of cyclododecane from butadiene. Butadiene may be cyclized to 1,5,9-cyclododecatriene, which may then be hydrogenated using the recovered hydrogen to form cyclododecane and/or cyclododecene, which can be oxidized with nitric acid to form dodecanedioic acid. The cyclododecane may then be further reacted to form laurolactam, the monomer for nylon 12. See Wittcoff et al., Industrial Organic Chemicals in Perspective Part I: Raw Materials and Manufacture (1991), pp. 82-84, the entirety of which is hereby incorporated by reference. It should be noted that the amount of nitrogen in the off-gas will impact the economic feasibility of recovering hydrogen from the off-gases rather than burning the off-gases in a boiler. Other compositions or ingredients can also impact the desirability of recovering hydrogen. For example, in the event that the HCN concentration in the off-gas stream, as measured by on-line sensors, exceeds a predetermined maximum value, the off-gas stream can be redirected to either the steam-generating boilers or to a flare rather than proceeding to hydrogen recovery.

Thus, in one embodiment, the present invention comprises a process for producing hydrogen cyanide comprising reacting a ternary gas mixture in the presence of a catalyst to form a crude hydrogen cyanide product comprising hydrogen cyanide and off-gas, separating the crude hydrogen cyanide product to form a hydrogen cyanide product stream and an ammonia stream, and an off-gas stream comprising hydrogen, water, carbon monoxide and carbon dioxide; separating the off-gas stream to form a hydrogen product stream comprising hydrogen and a purge stream comprising carbon monoxide, carbon dioxide and water; and recovering hydrogen cyanide from the hydrogen cyanide product stream.

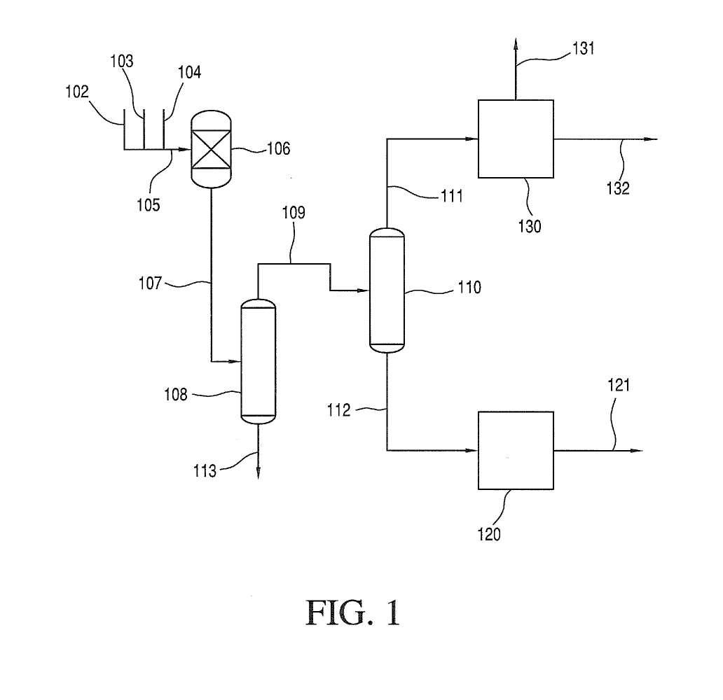

As is shown in FIG. 1, the ternary gas mixture 105 comprises a methane-containing gas 102, an ammonia-containing gas 103, and an oxygen-containing gas 104. As described herein, in order to make the recovery of hydrogen economically and energetically feasible, the oxygen content in the oxygen-containing gas 104 is greater than 21 vol. %, e.g., oxygen-enriched air or pure oxygen. In some embodiments, the oxygen content in the oxygen-containing gas 104 is at least 28 vol. % oxygen, e.g., at least 80 vol. % oxygen, at least 95 vol. % oxygen, or at least 99 vol. % oxygen.

The amount of oxygen present in the ternary gas mixture 105 is controlled by flammability limits. Certain combinations of air, methane and ammonia are flammable and will therefore propagate a flame following ignition. A mixture of air, methane and ammonia will burn if the gas composition lies between the upper and lower flammability limits Mixtures of air, methane and ammonia outside of this region are typically not flammable. The use of oxygen-enriched air changes the concentration of combustibles in the ternary gas mixture. Increasing the oxygen content in the oxygen-containing gas feed stream significantly broadens the flammable range. For example, a mixture containing 45 vol. % air and 55 vol. % methane is considered very fuel-rich and is not flammable, whereas a mixture containing 45 vol. % oxygen and 55 vol. % methane is flammable.

An additional concern is the detonation limit. For example, at atmospheric pressure and room temperature, a gas mixture containing 60 vol. % oxygen, 20 vol. % methane and 20 vol. % ammonia can detonate.

Thus, while the use of oxygen-enriched air in the production of HCN has been found to be advantageous, the enrichment of air with oxygen necessarily leads to a change in the concentration of combustibles in the ternary gas mixture and such a change in the concentration of combustibles increases the upper flammability limit of the ternary gas mixture fed to the reactor. Deflagration and detonation of the ternary gas mixture is, therefore, sensitive to the oxygen concentration. The term “deflagration” as used herein refers to a combustion wave propagating at subsonic velocity relative to the unburned gas immediately ahead of the flame. “Detonation,” on the other hand, refers to a combustion wave propagating at supersonic velocity relative to the unburned gas immediately ahead of the flame. Deflagrations typically result in modest pressure rise whereas detonations can lead to extraordinary pressure rise.

While others have suggested use of oxygen-enriched air for increasing HCN production capacity, they typically avoid operating in the flammable region. See U.S. Pat. Nos. 5,882,618; 6,491,876 and 6,656,442, the entireties of which are incorporated herein by reference. In the present invention, the oxygen-enriched air or pure oxygen feed is controlled to form a ternary gas mixture within the flammable region, but not within the detonable region. Thus, in some embodiments, the ternary gas mixture comprises at least 25 vol. % oxygen, e.g., at least 28 vol. % oxygen. In some embodiments, the ternary gas mixture comprises from 25 to 32 vol. % oxygen, e.g., from 26 to 30 vol. % oxygen. The ternary gas mixture may have a molar ratio of ammonia-to-oxygen from 1.2 to 1.6, e.g., from 1.3 to 1.5, a molar ratio of ammonia-to-methane from 1 to 1.5, e.g., from 1.10 to 1.45, and a molar ratio of methane-to-oxygen of 1 to 1.25, e.g., from 1.05 to 1.15. For example, a ternary gas mixture may have a molar ratio of ammonia-to-oxygen of 1.3 and methane-to-oxygen 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios.

The ternary gas mixture 105 is fed to the reactor 106 where it is passed over a catalyst to form a crude hydrogen cyanide product 107. The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures including woven, non-woven and knitted configurations, wire gauze, tablets, pellets, monoliths, foams, impregnated coatings, and wash coatings. The catalyst must be sufficiently strong to withstand increased velocity rates that may be used in combination with a ternary gas mixture comprising at least 25 vol. % oxygen. Thus, a 85/15 platinum/rhodium alloy may be used on a flat catalyst support. A 90/10 platinum/rhodium alloy may be used with a corrugated support that has an increased surface area as compared to the flat catalyst support.

Typically, crude hydrogen cyanide product 107, when produced using pure oxygen, may comprise from 34 to 36 vol. % hydrogen, e.g., from 34 to 35 vol. %, and is cooled in a heat exchanger prior to exiting the reactor. Crude hydrogen cyanide product 107 may be cooled from up to 1200° C. to less than 500° C., less than 400° C., less than 300° C. or less than 250° C. Exemplary crude hydrogen cyanide product compositions are shown below in Table 1.

TABLE 1
CRUDE HYDROGEN CYANIDE PRODUCT COMPOSITIONS

| Nominal Composition, | Oxygen Andrussow | Air Andrussow |
|---|---|---|
| vol. %: | Process | Process |
| H₂ | 34.5 | 13.3 |
| N₂ | 2.4 | 49.2 |
| CO | 4.7 | 3.8 |
| Ar | 0.1 | |
| CH₄ | 0.8 | 0.3 |
| CO₂ | 0.4 | 0.4 |
| NH₃ | 6.6 | 2.3 |
| HCN | 16.9 | 7.6 |
| Other nitriles | <0.1 | ** |
| H₂O | 33.4 | 23.1 |

As is shown in Table 1, preparing HCN using the air process only produces 13.3 vol. % hydrogen, while the oxygen process results in an increased hydrogen concentration of 34.5 vol. %. The amount of hydrogen may vary depending on oxygen concentration of the feed gases and ratios of reactants, and may range from 34 to 36 vol. % hydrogen. In addition to Table 1, oxygen concentration of the crude hydrogen cyanide product is low, preferably less than 0.5 vol. %, and higher amounts of oxygen in the crude hydrogen cyanide product may trigger shut down events or necessitate purging. Depending on the molar ratios of ammonia, oxygen and methane used, the crude hydrogen cyanide product formed using the Oxygen Andrussow Process may vary as shown in Table 2.

TABLE 2
CRUDE HYDROGEN CYANIDE PRODUCT COMPOSITIONS
USING OXYGEN ANDRUSSOW PROCESS

| | Vol. % | Vol. % |
|---|---|---|
| H₂ | 20 to 50 | 30 to 40 |
| N₂ | 1 to 5 | 1 to 4 |
| CO | 0.5 to 10 | 1 to 5 |
| Ar | 0.01 to 1 | 0.05 to 0.5 |
| CH₄ | 0.05 to 1 | 0.1 to 1 |
| CO₂ | 0.01 to 3 | 0.1 to 0.5 |
| NH₃ | 5 to 15 | 5 to 10 |
| HCN | 12 to 20 | 14 to 18 |
| Other nitriles | <0.1 | ** |
| H₂O | 25 to 50 | 30 to 40 |

Crude hydrogen cyanide product 107 is then separated, after an initial separation to remove ammonia in an ammonia absorber 108 as described herein, using an HCN absorber 110, to form an off-gas stream 111 comprising hydrogen, water, carbon dioxide and carbon monoxide; and a hydrogen cyanide product stream 112, comprising hydrogen cyanide. The hydrogen cyanide product stream comprises less than 10 vol. % hydrogen, e.g., less than 5 vol. % hydrogen, less than 1 vol. % hydrogen, less than 100 mpm hydrogen, or is substantially free of hydrogen. It is preferably for a majority of the hydrogen to concentrate in off-gas stream 111. A comparison of off-gas stream 111 after separation from crude hydrogen cyanide product 107, for the pure oxygen Andrussow process and for a comparable air Andrussow process, and the amount of nitrogen in each of such processes is tabulated below in Table 3.

TABLE 3
COMPARISON OF HCN OFF-GAS STREAM COMPOSITIONS

| Nominal Composition, | Oxygen Andrussow | Air Andrussow |
|---|---|---|
| vol. % | Process | Process |
| H2 | 80.1 | 16.61 |
| N2 | 5.6 | 76.32 |
| CO | 11.0 | 4.44 |
| AR | 0.2 | 0.48 |
| O2 | 0.2 | — |
| CH4 | 1.6 | 0.83 |
| CO2 | 0.8 | 0.29 |
| NH3 | — | — |
| HCN | 0.1 | 0.11 |
| Other nitriles | Trace | 0.01 |
| H₂O | 0.4 | 0.91 |

As shown in Table 3, when an oxygen Andrussow Process is used, the off-gas stream 111 comprises greater than 80 vol. % hydrogen. In some embodiments, the off-gas stream 111 comprises from 40 to 90 vol. % hydrogen, e.g., from 45 to 85 vol. % hydrogen or from 50 to 80 vol. % hydrogen. The off-gas stream 111 may further comprise from 0.1 to 20 vol. % water, e.g., from 0.1 to 15 vol. % water or from 0.1 to 10 vol. % water. The off-gas stream 111 may further comprise from 0.1 to 20 vol. % carbon monoxide, e.g., from 1 to 15 vol. % carbon monoxide or from 1 to 10 vol. % carbon monoxide. The off-gas stream 111 may further comprise from 0.1 to 20 vol. % carbon dioxide, e.g., from 0.1 to 5 vol. % carbon dioxide or from 0.1 to 2 vol. % carbon dioxide. In one embodiment, the off-gas stream 111 comprises 78 vol. % hydrogen, 12 vol. % carbon monoxide, 6 vol. % carbon dioxide and the balance of water and hydrogen cyanide. The off-gas stream 111 may also comprise trace amounts of nitriles, and small amounts of additional components, including methane, ammonia, nitrogen, argon and oxygen. Higher amounts of these components may trigger an operational shutdown, in particular higher concentrations of oxygen. Preferably, these additional components are present at a total of less than 10 vol. %. The amount of nitrogen is less than 20 vol. %, e.g., less than 15 vol. %, or less than 10 vol. %.

As described herein, the off-gas stream 111 may be separated using a PSA unit 130. A typical PSA process and apparatus is described in U.S. Pat. Nos. 3,430,418 and 3,986,849, the entireties of which are hereby incorporated by reference. The PSA 130 may comprise at least 2 beds, e.g., at least 3 beds or at least 4 beds, and is operated at a pressure from 1400 kPa to 2600 kPa, e.g., 1400 kPa to 2400 kPa, from 1600 kPa to 2300 kPa or from 1800 kPa to 2200 kPa. The PSA 130 is operated at a temperature from 16 to 55° C.; e.g. from 20 to 50° C. or from 30 to 40° C. The PSA may be a polybed PSA. Each bed comprises adsorbents. In some embodiments, each bed comprises the same adsorbents. In other embodiments, each bed comprises different adsorbents. The adsorbents may be conventional adsorbents used in PSA units including zeolites, activated carbon, silica gel, alumina, and combinations thereof. In particular, a combination of zeolites and activated carbon may be used. The cycle time through each bed may range from 150 to 210 seconds, e.g., from 180 to 200 seconds and the total cycle time may range from 300 seconds to 1000 seconds, e.g., 400 seconds to 900 seconds, depending on the number of beds used.

The off-gas stream 111 is separated in PSA 130 to form a hydrogen product stream 132 and a purge stream 131. The hydrogen product stream 132 may be considered a high purity hydrogen product stream and comprises at least 95 vol. % hydrogen, e.g., at least 99 vol. % hydrogen, at least 99.5 vol. % hydrogen, or at least 99.9 vol. % hydrogen. The purge stream 131 comprises carbon dioxide, carbon monoxide, water, and hydrogen. The purge stream 131 may be burned as fuel.

Recovering hydrogen by using a PSA 130 allows at least 70% hydrogen from the crude hydrogen cyanide product 107 to be recovered, e.g., at least 72.5%, at least 75% or at least 76%.

Returning to FIG. 1, the crude hydrogen cyanide product 107 may be subjected to further processing steps prior to separation of the off-gas from the crude hydrogen cyanide product 107. The Andrussow process, when practiced at optimal conditions, has potentially recoverable residual ammonia in the hydrogen cyanide product stream. Because the rate of HCN polymerization increases with increasing pH, residual ammonia must be removed to avoid the polymerization of the HCN. HCN polymerization represents not only a process productivity problem, but an operational challenge as well, since polymerized HCN can cause process line blockages resulting in pressure increases and associated process control problems. Once the crude hydrogen cyanide product has been cooled, residual ammonia may be removed from the crude hydrogen cyanide product prior to separating the off-gas from the crude hydrogen cyanide product. Removing the ammonia may be accomplished using ammonia removal unit 108, which may include scrubbers, strippers, and combinations thereof. At least a portion of crude hydrogen cyanide product 107 may be directed to ammonia scrubbers, absorbers and combinations thereof 108, to remove residual ammonia. In this ammonia separation, off-gas stream 111 components are kept with the crude hydrogen cyanide product and are not removed with any recoverable residual ammonia.

The crude hydrogen cyanide product, after ammonia removal, 109 comprises less than 1000 mpm, ammonia, e.g., less than 500 mpm or less than 300 mpm. The ammonia stream 113 may be recycled to the reactor 106 or to the ternary gas mixture 105 for re-use as a reactant feed. HCN polymerization is inhibited by immediately reacting the hydrogen cyanide stream with an excess of acid (e.g., H₂SO₄ or H₃PO₄) such that the residual free ammonia is captured by the acid as an ammonium salt and the pH of the solution remains acidic. Formic acid and oxalic acid in crude hydrogen cyanide product 107 are captured in aqueous solution in an ammonia recovery system as formates and oxalates.

The crude hydrogen cyanide product 109 may then be separated to remove off-gas, as described herein, to form the hydrogen cyanide product stream 112. This stream 112 may be further processed in HCN refining zone 120 to recover a finished hydrogen cyanide stream 121 for hydrocyanation. The term “hydrocyanation” as used herein is meant to include hydrocyanation of aliphatic unsaturated compounds comprising at least one carbon-carbon double bond or at least one carbon-carbon triple bond or combinations thereof, and which may further comprise other functional groups including, but not limited to, nitriles, esters, and aromatics. Examples of such aliphatic unsaturated compounds include, but are not limited to, alkenes (e.g., olefins); alkynes; 1,3-butadiene; and pentenenitriles. Hydrocyanation may include 1,3-butadiene and pentenenitrile hydrocyanation to produce adiponitrile (ADN). ADN manufacture from 1,3-butadiene involves two synthesis steps. The first step uses HCN to hydrocyanate 1,3-butadiene to pentenenitriles. The second step uses HCN to hydrocyanate the pentenenitriles to adiponitrile (ADN). This ADN manufacturing process is sometimes referred to herein as hydrocyanation of butadiene to ADN. ADN is used in the production of commercially important products including, but not limited to, 6-aminocapronitrile (ACN); hexamethylenediamine (HMD); epsilon-caprolactam; and polyamides such as nylon 6 and nylon 6,6.

The HCN recovered from the finished hydrogen cyanide stream 121 is uninhibited HCN. The term “uninhibited HCN” as used herein means that the HCN is substantially depleted of stabilizing polymerization inhibitors. As understood by those skilled in the art, such stabilizers are typically added to minimize polymerization of HCN and require at least partial removal of the stabilizers prior to utilizing the HCN in hydrocyanation of, for example, 1,3-butadiene and pentenenitrile to produce ADN. HCN polymerization inhibitors include, but are not limited to mineral acids, such as sulfuric acid and phosphoric acid; organic acids such as acetic acid; sulfur dioxide; and combinations thereof.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units (i.e., CPUs), computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

The invention can be further understood by reference to the following examples.

### Example 1

A ternary gas mixture is formed by combining pure oxygen, an ammonia-containing gas and a methane-containing gas. The ammonia-to-oxygen molar ratio in the ternary gas mixture is 1.3:1 and the methane-to-oxygen molar ratio in the ternary gas mixture is from 1.2:1 The ternary gas mixture, which comprises from 27 to 29.5 vol. % oxygen, is reacted in the presence of a platinum/rhodium catalyst to form a crude hydrogen cyanide product comprising from 34 to 36 vol. % hydrogen. Hydrogen forms during the reaction. The crude hydrogen cyanide product is removed from the reactor and sent to an ammonia removal unit to separate residual ammonia from the crude hydrogen cyanide product. The crude hydrogen cyanide product is then sent to an absorber to form an off-gas and a hydrogen cyanide product stream. The off-gas has a composition as is shown in Table 3, Oxygen Andrussow Process, and is compressed to a pressure of 2275 kPa and is sent to a PSA unit. The PSA unit comprises four beds, each bed comprising activated carbon and zeolite. Each bed adsorbs non-hydrogen components in the off-gas, such as nitrogen, carbon monoxide, carbon dioxide, and water. The PSA is operated at a temperature of 40° C. for a total cycle time of 800 seconds (approximately 190 seconds in each bed). 75 to 80% of the hydrogen from the crude hydrogen cyanide product is recovered in a hydrogen stream. The hydrogen stream has a purity of 99.5% or higher.

### Comparative Example A

An off-gas is separated as indicated in Example 1, except that air is used instead of pure oxygen to form the ternary gas mixture. Thus the ternary gas mixture would have less than 25 vol. % oxygen and an increased nitrogen concentration. The ammonia separation equipment would be larger in size than the equipment used in Example 1, and the absorber would be larger than in Example 1 due to the increased amount of nitrogen as compared to Example 1. The off-gas composition is shown in Table 3, Air Andrussow Process. The off-gas is compressed and sent to the PSA unit used in Example 1. The number of compressors is eight times larger than the number of compressors required to compress the off-gas in Example 1. In addition, during compression, cooling stages will be used due to heat generated by compressing large volumes of nitrogen. After the non-hydrogen components are adsorbed in the first bed, the PSA is no longer operable due to an insufficient volume of hydrogen. It is not economically or energetically feasible to recover hydrogen. Thus, further integration with HMD production is not possible.

1-15. (canceled)

16. A process for producing hydrogen cyanide comprising:
(a) determining methane content of a methane-containing gas and purifying the methane-containing gas when the methane content is determined to be less than 90 vol. %;
(b) reacting a ternary gas mixture comprising at least 25 vol. % oxygen in the presence of a catalyst to form a crude hydrogen cyanide product comprising hydrogen cyanide and off-gas, the ternary gas mixture comprising the methane-containing gas, an ammonia-containing gas, and an oxygen-containing gas;
(c) separating the crude hydrogen cyanide product to form a hydrogen cyanide product stream comprising hydrogen cyanide, and an off-gas stream comprising hydrogen, water, carbon monoxide, and carbon dioxide;
(d) separating the off-gas stream to form a hydrogen product stream comprising hydrogen, and a purge stream comprising carbon monoxide, carbon dioxide and water; and
(e) recovering hydrogen cyanide from the hydrogen cyanide product stream.

17. The process of claim 16, wherein the ternary gas mixture comprises from 25 to 32 vol. % oxygen.

18. The process of claim 16, wherein the oxygen-containing gas comprises at least 80 vol. % oxygen.

19. The process of claim 16, wherein the oxygen-containing gas comprises pure oxygen.

20. The process of claim 16, wherein the off-gas stream is compressed to a pressure from 130 kPa to 2600 kPa.

21. The process of claim 16, wherein the off-gas stream comprises:
(a) from 40 to 90 vol. % hydrogen;
(b) from 0.1 to 20 vol. % water;
(c) from 0.1 to 20 vol. % carbon monoxide;
(d) from 0.1 to 20 vol. % carbon dioxide; and
(e) less than 20 vol. % nitrogen.

22. The process of claim 16, wherein the off-gas stream is separated using a pressure swing adsorber, a molecular sieve, or a membrane.

23. The process of claim 22, wherein each adsorption bed in the pressure swing adsorber adsorbs non-hydrogen components in the off-gas.

24. The process of claim 22, wherein the pressure swing adsorber is operated at a pressure from 1400 kPa to 2600 kPa.

25. The process of claim 22, wherein the pressure swing adsorber is operated at a temperature from 16 to 55° C.

26. The process of claim 22, wherein the pressure swing adsorber comprises at least two adsorption beds.

27. The process of claim 26, wherein each of the at least two adsorption beds comprises at least one adsorbent selected from the group consisting of zeolites, activated carbon, silica gel, alumina, and combinations thereof.

28. The process of claim 16, wherein the hydrogen product stream comprises at least 95 vol. % hydrogen.

29. The process of claim 16, wherein the hydrogen product stream comprises at least 99 vol. % hydrogen.

30. The process of claim 16, wherein the hydrogen cyanide product stream comprises less than 10 vol. % hydrogen.

31. The process of claim 16, wherein the hydrogen cyanide product stream is substantially free of hydrogen.

32. The process of claim 16, wherein at least 70% of hydrogen from the crude hydrogen cyanide product is recovered in the hydrogen product stream.

33. A process for producing hydrogen cyanide comprising:
(a) determining methane content of a methane-containing gas and purifying the methane-containing gas when the methane content is determined to be less than 90 vol. %;
(b) reacting a ternary gas mixture comprising at least 25 vol. % oxygen in the presence of a catalyst to form a crude hydrogen cyanide product comprising hydrogen cyanide and off-gas, the ternary gas mixture comprising the methane-containing gas, an ammonia-containing gas, and an oxygen-containing gas;
(e) separating the crude hydrogen cyanide product to form a hydrogen cyanide product stream comprising hydrogen cyanide, an ammonia stream, and an off-gas stream comprising hydrogen, water, carbon monoxide, and carbon dioxide;
(d) separating the off-gas stream to form a hydrogen product stream comprising hydrogen, and a purge stream comprising carbon monoxide, carbon dioxide and water; and
(e) recovering hydrogen cyanide from the hydrogen cyanide product stream.

34. The process of claim 33, wherein at least a portion of the ammonia stream is returned to the reactor.

35. A process for recovering hydrogen from an Andrussow process comprising:
(a) reacting a ternary gas mixture comprising at least 25 vol. % oxygen in the presence of a catalyst to form a crude hydrogen cyanide product comprising hydrogen cyanide and off-gas, the ternary gas mixture comprising the methane-containing gas, an ammonia-containing gas, and an oxygen-containing gas;
(b) separating the crude hydrogen cyanide product to form a hydrogen cyanide product stream comprising hydrogen cyanide, and an off-gas stream comprising hydrogen, water, carbon monoxide, and carbon dioxide; and
(c) separating the off-gas stream in a pressure swing adsorber to recover hydrogen.
